(19) United States
(12) Patent Application Publication
(10) Pub. No.: US 2011/0254398 A1
(43) Pub. Date: Oct. 20, 2011

(54) Self-contained & propelled magnetic alternator & flywheel directdrive generator aka:MAW-directdrives flywheel generator

(75) Inventor: Dana Allen Hansen, Torrance, CA (US)

(73) Assignee: Dana Allen Hansen, Torrance, CA (US)

(21) Appl. No.: 12/799,203

(22) Filed: Apr. 20, 2010

(51) Int. Cl. H02K 47/20; H02K 53/00

(52) U.S. Cl. 310/113; 415/916

(57) ABSTRACT

MAW-DirectDrives Flywheel Generators are self-contained directly driven large-scale flywheels suspended within a stationary housing affixed below a strong drive-plate and spindle sub-assembly joined to the housing via the housing's central wheel hub assembly. The rotating flywheel is driven by one of four to ten frameless direct drive alternator stators secured from the top of the housing in tuned and matched pairs with each pair separated facing one another with a two-sided permanent magnets drive-rotor between connected to the drive-plate. The flywheel is utilized to distribute the workload out to a larger area to gain the ability to engage more stators in work and transform the kinetic energy present within the rotating flywheel through the work of the additional stators operating more efficiently in their tuned and matched configuration. The electrical input needed to maintain the velocity of the flywheel is regenerated through the work process boosting the output current density.

### CROSS-REFERENCE TO RELATED APPLICATIONS

This non-provisional utility patent application references my customer number: #000079682. This application also references my provisional patent application: No. 61/209,671 filed on Mar. 10, 2009. Additional applications being referenced are: Provisional patent application No. 61/124,179 filed on Apr. 15, 2008 and Non-provisional Utility patent application Ser. No. 12/386,047 filed on Apr. 13, 2009 under Class/Subclass: 180/065.510 having a Publication No. US 2009-0255742 A1.

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

1. Field of the Invention

MAW-DirectDrives Flywheel Generators hence forward referenced “Flywheel Generator/Generators” are designed and created to utilize the kinetic energy within a rotating flywheel to regenerate electrical power and boost its current density and/or quick charge all electric vehicles/batteries.

“Flywheel Generators” use current technological goods produced for the electromagnetic power and generating sectors in a unique format that enhance the efficiency of those products by uniting multiple units together and timing their operation to become complementary to each other as a unit and eliminate losses with the production of electromagnetic power and generation.

Physical and Scientific Laws of Thermodynamics, Electromagnetic and Conservation are employed using state of the art materials creating exact parts specifications working in union with the strongest most powerful magnetic fields maintained at the optimum operating temperatures within an environment perfect to transform and convert the flywheel's linear and angular momentum now spread over a large working surface to electromagnetic power.

The productive output ratio will be relative to the number, size and wind of the stators incorporated into each respective unit and to the specific grade of rare earth magnets utilized in its operation.

The flywheel's specifications incorporated into each unit correspond to the aspect of the unit's application such as production only or a production and storage unit using the flywheel as an electrical recharge mechanism working in conjunction with computer controlled regenerative braking technology controlling delivery.

“Flywheel Generators” will regenerate electrical power and boost its current density at distribution and/or reconditioning points along the transmission line or at the final destination point where deployed/needed to lessen the cost and losses associated with delivery/transmission.

“Flywheel Generators” utilize recyclable materials in their construction to aid and reduce in the cost of their own future manufacturing.

The “Flywheel Generator's” simple design using dependable proven technology will facilitate an extended life span, easy assembly and maintenance to reduce costs and overhead.

2. Description of Related Art

Different elements producing electricity: in original states requiring no modification for utilization like water, wind and geothermal steam and altered states requiring modification/processing for utilization like induced steam (nuclear, coal, petrochemical and etc.) and engines (diesel, gas, steam and etc.) produce linear motion for the transformation/conversion to torque/rotation needed to generate electromagnetic power.

Elements utilized closest to their origin without processing are the most efficient and economical producing the least amount of heat and losses associated with operation.

Present technology to recondition and/or process electrical power for transmission further down the line or distribution from its final destination is inefficient and every encounter reduces the efficiency of the generated electrical power thus diminishing the efficiency of the generated electrical power in proportion to the amount of needed processing and the span traveled.

With the vast majority of electrical power produced being of hydroelectric, nuclear, wind and steam based requiring extended transmission lines from their production points and locally/portable hybrid engine based units the efficiency ratio is low and all these formats are derived from the transformation of linear motion into angular momentum for the production of electromagnetic power.

“Flywheel Generators” use their angular momentum as the origin of their nature and their linear momentum as the basis for their workload capacity and their high efficiency ratio generated by elements of their design to achieve a boost in output over input current density.

The useful element of portability allows local/pinpoint placement of “Flywheel Generators” and their design's small footprint facilitate convenient inline/onsite positioning for maintaining the integrity of the transmitted/generated electrical power.

### BRIEF SUMMARY OF THE INVENTION

A MAW-DirectDrives Flywheel Generator is a multi stator generator that encases from four to ten frameless direct drive brushless DC/AC motor/alternator stators within a custom housing.

They are designed to transform the kinetic energy present within the flywheel by utilizing the rotation/angular momentum and its linear momentum to operate multiple frameless direct drive brushless DC/AC alternator stators (typically incorporated within the highest efficient wind generation technology) simultaneously.

A single stator maintains the rotational speed/velocity of a large-scale flywheel attached to a drive-plate assembly possessing one two-sided rare earth permanent magnets drive-rotor ring between each pair of stators positioned face-to-face, interacting to and with their drive-rotor in tuned stages.

When the overall resistance is calculated for the “Flywheel Generator's” operation this sets the workload and determines the drive stator to maintain the flywheel's velocity and by subtracting the drive stator's needs from the overall output of the remaining stators the difference is your output production/current density boost.

For achieving an efficiency capable of producing a profitable output each stage within the unit is tuned and matched having opposing stators with identical winds and internal components mirror in physical position and operation working in union and in unison with their respective two-sided permanent magnets drive-rotor ring possessing on both sides equal numbers of rare earth magnet Arc-Segments located exactly on the same projection lines off center equal in length and strength with the larger radiuses polarity matching.

Timing the unit sets the location of the two-sided rare earth magnets drive-rotor rings timing line (leading edge of 1^{st} magnet) from the reference point: 0° half-line off center to achieve maximum efficiency by using the magnetic fields location on each stage to assist the other stages.

The drive-plate's rear face has a spindle projecting upwards at center through the central wheel hub assembly projecting down from the center of the custom housing holding the stators in position and secures the “integrated drive-plate assembly” to the custom housing in a unique zero tolerance fashion.

The wheel hub incorporates sealed taper roller bearings having identical outside diameters to reduce maintenance plus machining time and needed tooling, in addition one thick spacing washer and the necessary shim washers accounting for the exact clearance between the spindles external retaining ring and tightened nut are used for assembling unit, then to seal the wheel hub from the elements a metal wheel hub cover is pressed in.

The custom housing's casting is designed needing minimal machining with only one counterboring operation to the interior's wheel hub for truing to the housing and proper alignment for the “integrated drive-plate assembly” with all remaining drilling operations for the unit's operation machined from the outside to simplify plus expedite their manufacture and minimize overhead.

For reducing size to accommodate more stages for greater output and maintain the proper operating temperature and specified tolerances stators surrounding the innermost stator and its ribbed mounting back are affixed to liquid cooled mounting backs designed for the structural support and cooling of two stators one on each side.

All stators are manufactured encapsulated in resin and ground to their respective finish dimension(s) to maintain concentricity and meet the rigid tolerances these parts demand.

Existing atop the stator mounting backs on their median diameter are threaded mounting holes corresponding to specifications and matching the housing's mounting holes exactly.

Each two-sided rare earth permanent magnets drive-rotor ring hence forward referenced “drive-rotor” is recessed-in at the top inside and outside to accommodate Neodymium rare earth magnets that are secured, protrudes out and ground to the finish dimensions and specifications then nickel coated for protection by electroless plating.

Each drive-rotor base on the median diameter has threaded mounting holes corresponding to specifications and location holes for dowel pins to maintain concentricity that match mounting and location holes on the drive-plate.

Centered atop the outer-most drive-rotor are small Neodymium magnet discs working with a Hall-effects sensor coming in from above to monitor and maintain the flywheel's velocity.

Positioned atop the housing is an casted annular shaped compressed air chamber/encasement tightly secured by machine screws through built-in bosses on the inner and outer outside edges fed by two or more input lines for cooling internal components by/with airflow entering via numerous holes in the housing's top positioned above the drive-rotors' operating sectors and exiting out the housing's side via exhaust openings.

### BRIEF DESCRIPTION OF THE SEVERAL VIEWS OF THE DRAWING

This patent application includes six drawings and two charts diagramming efficiency and output production estimations.

FIG. 1: is a scale drawing of a cross-sectional view on the vertical plane of a “MAW-DirectDrives Flywheel Generator” shown is a Basic 6 stator compressed air and liquid cooled version with a base 48″OD, housing 45″OD×29″ H and flywheel 42″OD×13″H.

FIG. 2: is a scale drawing of the bottom view of the 40″OD custom drive-plate incorporated into the Basic 6 stator compressed air and liquid cooled version presented within this patent application as reference information.

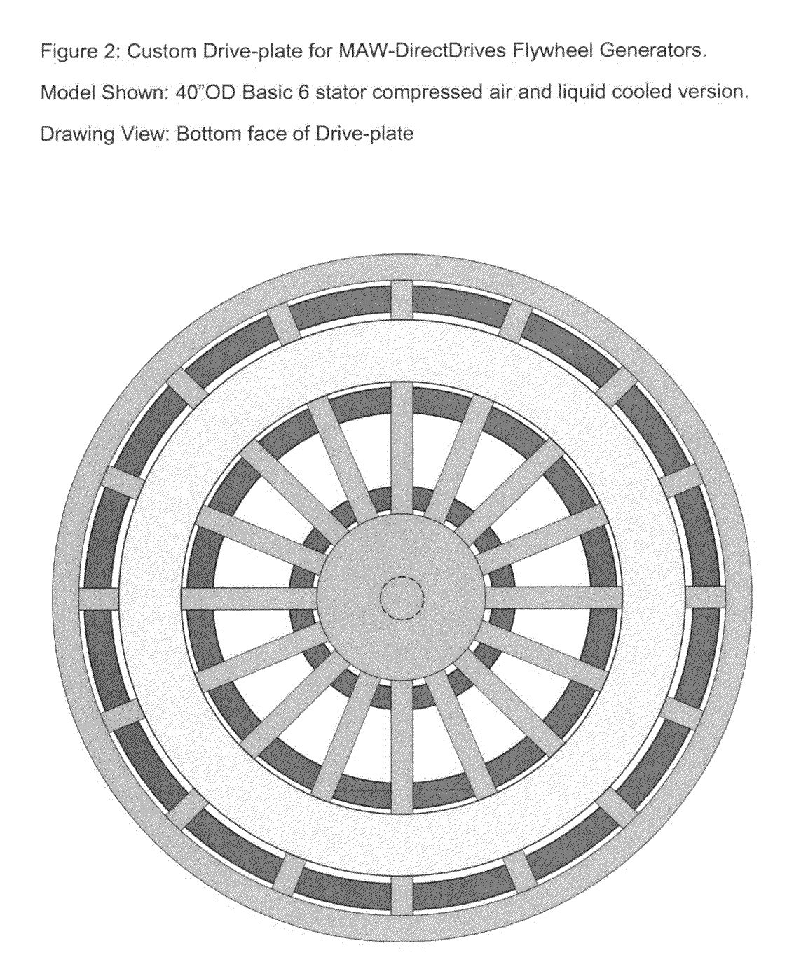

FIG. 3: is a chart diagramming four different sized “MAW-DirectDrives Flywheel Generators” with their specifications and output production estimations.

FIG. 4: is a chart diagramming the relationship of size/diameter to efficiency with Direct Drive Frameless Brushless Permanent Magnets Servomotors.

FIG. 5: is a scale drawing showing the top view of a liquid cooled stator mounting back with the end view of the mounting back extrusion showing the water passageway configuration and side view of the fluid inlet-outlet casting showing the beveling on the extrusion ends and the reverse beveling on the fluid inlet-outlet casting sides for welding together and forming a circle.

FIG. 6: is a scale drawing showing the top view of the basic 6 stator compressed air and liquid cooled version of “MAW-DirectDrives Flywheel Generators” used within this patent application.

FIG. 7: is a scale drawing showing the front view of a “MAW-DirectDrives Flywheel Generator” housing to illustrate the housing's air filtration and cooling features.

FIG. 8: are specifications and scale drawings showing the profile and outside edge views of the extrusion for constructing housing air filter frames and an enlarged profile view to aid detailing specifications and showing structural radiuses incorporated for strength, extrusion die and Electrical discharge machining (EDM) requirements.

### DETAILED DESCRIPTION OF THE INVENTION

“MAW-DirectDrives Flywheel Generators” were initially created to recharge all electric vehicles by utilizing a large-scale heavyweight flywheel's linear momentum/rotational kinetic energy as the stored energy to convert to electrical power incorporating present frameless direct drive permanent magnets brushless and synchronous alternator technological goods mirroring manufacturing standards formulated within “MAW-DirectDrives” Non-provisional Utility Patent: US 2009-0255742A1.

MAW-DirectDrives are self-propelled independent direct drive units that connect to the inside of wheels to actuate and stop motion electromagnetically and utilize the induced rotation to generate electricity via the incorporation of two frameless direct drive permanent magnets BLDC stators connected to a stationary platform around a built-in wheel hub assembly which face one another and are separated between to insert and interact with a two-sided permanent magnets drive-rotor ring connected to the back of a drive-plate and spindle sub-assembly connected to the stationary platform via the wheel hub.

Flywheel Generators are self-contained directly driven large-scale flywheels suspended within a structurally sound stationary housing affixed to a strong drive-plate and spindle sub-assembly possessing from two to five two-sided permanent magnets drive-rotors, which join and lock together via the housing's central wheel hub assembly projecting down between four to ten frameless direct drive permanent magnets brushless and synchronous alternator/motor stators working in pairs with the drive-rotors in tuned stages and secured via the housing's exterior.

Flywheel Generators incorporate paired stators in stages with each stage having identical winds and internal components that mirror in physical position and operation plus work in union and in unison with a two-sided permanent magnets drive-rotor ring possessing on both sides equal numbers of rare earth magnet Arc-Segments located exactly on the same projection lines off center, equal in length and strength with matching polarity on the larger radiuses, assembled acting as large individual magnets, a complementary relationship and tuning is achieved allowing their operation together within this particular stage to assist one another and defeat negative aspects associated with single stator/motor/alternator production of electromagnetic power and attain an efficiency requiring minimal force to sustain/produce operation.

Joining together additional stages and timing their operation in relation to their relative position within the magnetic field of the larger stator associated with that stage overall efficiency will be increased from their working affiliation and because efficiency increases exponentially in proportion to the increase in diameter due to the dynamics diameter and magnetic properties possess.

The efficiency gained and attributed to diameter and magnetic properties involves and relates to magnetic flux the property relating to attraction and repelling which work off the surface at right angles so the smoother or straight their parallel relation greater utilization is achieved and losses due to scattering that curvature inflicts are reduced as diameter increases.

Increasing the number of stages (stators) incorporated into a unit increases the overall surface area of the magnets involved in the operation of the unit and the power output is directly proportional to the surface area engaged in operation which is why diameter plays a big role in the overall output of the unit.

By tuning each stage and timing the unit's operation incorporating two stages will achieve a small increase in current density and utilizing additional stages increases the output production and the unit's efficiency due to the benefits diameter affords.

The application of the flywheel within these generators differs in physical properties according to the function they are employed to perform, such as engaged for what they were initially designed for a vehicle recharge mechanism where the heavier the flywheel the better and greater density will produce heavier flywheels for any given volume in proportion to the increase in the density factor whereas a flywheel's underlying principles of design configured for a standalone production format change because the benefit of greater density is displaced by the height factor with respect to the distribution of the predetermined weight and its speed/velocity whose predeterminations are based upon reference speeds associated with specific grades of Rare-earth magnets for the generating of electricity and the weight determined by the total overall workload associated with the operation of the unit.

The height of the flywheel is critical because its efficiency increases in proportion to the increase in height whose limit is set by the material's density factor or weight per cubic foot used in the flywheel's design specifications that ideally should utilize the least expensive recyclable materials with the correct properties plus lowest possible density factor to reduce overhead, minimize negative influences on nature plus take advantage of physical and scientific laws.

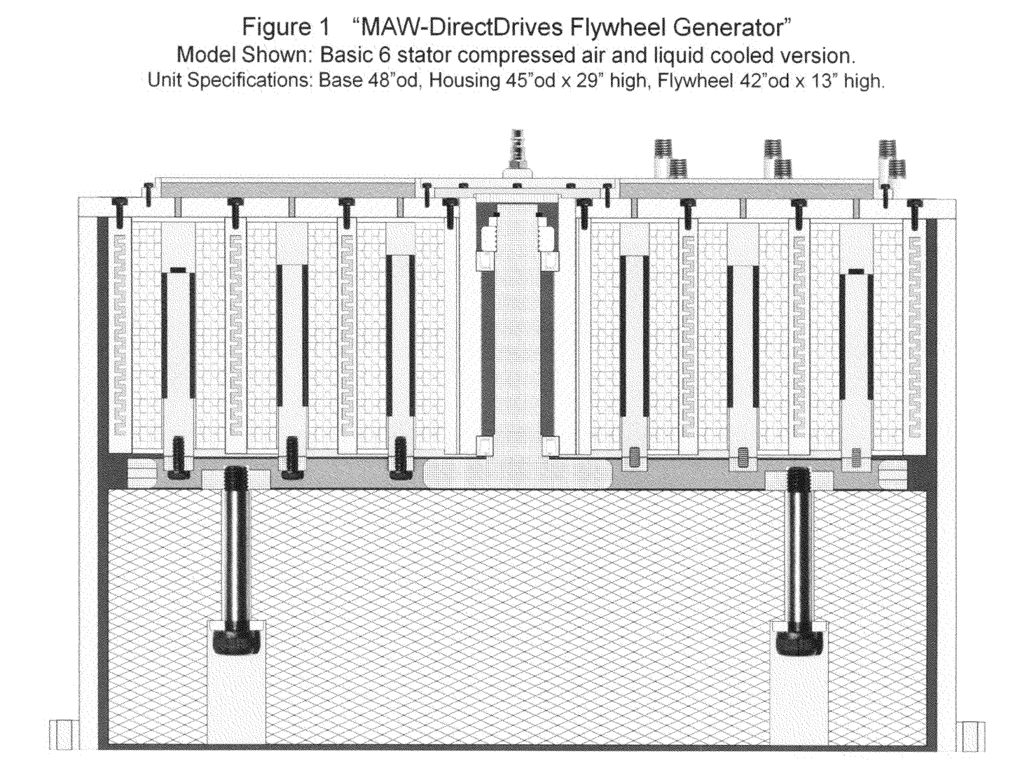

The flywheel shown in “FIG. 1” is 42″OD×13″high with a volume of 10.43 cu.ft. and a velocity of 3,250 SFM; when made of lead weighs 7,384 lbs. producing kinetic energy equaling 336,673 ft.lbs.T, when made of concrete weighs 1,543 lbs. producing kinetic energy equaling 70,353 ft.lbs.T and when made of polypropylene weighs 574 lbs. producing kinetic energy equaling 26,165 ft.lbs.T; minimum flywheel specifications account for overall workload plus emergency reserve also used to smooth operation; the lead flywheel is best for a production and recharge unit but inefficient requiring more energy to maintain the velocity than materials used with production units having less density complying with the minimum flywheel specifications which the unit shown needs 10,000 ft.lbs.T achieved using a 220 lbs. flywheel that can be constructed with the same external dimensions using 4 cu.ft. of polypropylene and 6.43 cu.ft. internal air space/chambers to take advantage of the height element.

Flywheel Generators incorporate a new innovative cooling design into the drive-plate and eliminate the inner and outer wheel hub seals by using sealed taper roller bearings and this design can also be utilized with “MAW-DirectDrives”, these improvements reduce weight, parts, cost and number of machining operations plus overall surface area engaged in those operations thus reducing machining time.

In the proceeding descriptions for the following assemblies, sub-assemblies and parts: drive-plate and spindle sub-assembly, drive-rotor(s), water cooled stator mounting back(s), stators and the external housing plus the compressed air chamber/encasement; all dimensions and specifications will reference the Basic 6 stator compressed air and liquid cooled version shown in “FIG. 1” and applicable for all sizes and versions of Flywheel Generators.

The drive-plate and spindle sub-assembly is a Precision investment casting made of 4340 alloy steel conforming to ASTM A320 standards and redesigned with sixteen evenly spaced spokes 22.5° on center, radiating from the hub to the rim on the same horizontal planes with raised inset annular shaped drive-rotor mounting rings mirroring the drive-rotors' positions and specifications on the inside. plus on the outside one raised inset annular shaped flywheel mounting ring centered on the bolt circle of the largest mounting back supporting two stators, on the drive-plate portion of this sub-assembly the raised inset annular shaped mounting rings are the only areas requiring machining and the spindle is now casted to its finish dimension between the inner and outer wheel bearings reducing the surface area machined.

Casting and finishing specifications for the aforesaid drive-plate and spindle sub-assembly are as follows: the drive-plate is 40.000″OD±0.005″×1.500″H±0.005″ R 1/32″ on the outside diameter top and bottom with the outer rim 1.500″W±0.005″ R⅜″ inside top and bottom with three 0.500″OD±0.010″ exhaust holes evenly spaced between every spoke and the hub 9.703″OD±0.005″ R⅜″ outside top and bottom connected by 16 spokes 1.250″W±0.005″×1.500″H±0.005″ R 1/32″ on both sides top and bottom plus IR⅜″ at both ends mating with the rim and hub, all these are finished dimensions and the following annular shaped mounting rings protrude out from the drive-plate 0.250″±0.005″ for machining to the finish specification of 0.125″±0.002″ with zero deviation off the horizontal planes: located on the bottom/backside is one flywheel mounting ring 27.125″ID±0.005″×30.625″±0.005″OD×1.00″H±0.005″ recessed-in 0.875″±0.005″ R 1/32″ on top inside edges with 16 threaded mounting holes 1⅛″-12 unf on a 28.875″BC evenly spaced 22.5° on center between the spokes' centerline; located on the topside are three (No 1 through No 3) drive-rotor mounting rings recessed-in 0.625″±0.005″ R 1/32″ on bottom inside edges and all have on their respective bolt circle(s) 0.5156″ID through holes for drive-rotor mounting and fifteen 0.500″ID±0.000″×0.890″deep±0.010″ location holes centered on the centerline of spokes No 2 through No 16 for drive-rotor timing, concentricity and assembly; all drive-rotor mounting rings reference tolerance and radius specifications specified for the flywheel mounting ring and have their mounting holes positioned centered between the spokes as per the flywheel mounting ring's; drive-rotor mounting ring No 1 is 10.6875″ID×13.3125″OD with 16 mounting holes evenly spaced 22.5° apart on a 12.000″BC, drive-rotor mounting ring No 2 is 21.6875″ID×24.5625″OD with 32 mounting holes evenly spaced 11.25° apart on a 23.125″BC, drive-rotor mounting ring No 3 is 33.1875″ID×36.3125″OD with 48 mounting holes evenly spaced 7.5° apart on a 34.750″BC, the spindle's centerline coincides with the drive-plate's and comes off the topside exactly perpendicular beginning with a boss/land cast to 3.500″OD±0.010″×0.250″H±0.005″ and machined to 0.125″H±0.005″ then steps down to the inner wheel bearing land ending 1.375″±0.005″ from the drive-plate cast to 2.750″OD±0.010″ and machined to 2.500″OD±0.0005″ with a 32 finish for Timken TSL series inner taper roller bearing No. 29586, then steps down to 2.375″OD±0.010″ cast surface between bearings terminating 9.500″±0.010″ from the drive-plate then stepping up to 2.625″OD±0.010″ to the end of casting 13.000″±0.010″ from the drive-plate machined to 12.875″±0.005″ from the drive-plate, the spindle's end is machined to 2.362″OD±0.0005″ to 9.500″±0.010″ from drive-plate with a 32 finish for Timken TSL series outer taper roller bearing No. 29522 and threaded to accommodate a 2⅜″-8 un retaining nut 1¼″th with the threads starting 11.625″±0.010″ from the drive-plate and terminating 10.500″±0.010″ from drive-plate then steps down to 2.250″OD±0.002″ with a 64 finish to the spindle's end that is grooved to accept a heavy duty external retaining ring 12.275″±0.005″ from the drive-plate out.

The drive-rotor(s) casting is made of 410 stainless steel conforming to ASTM A176 standards, using this alloy having magnetic properties aids drive-rotor assembly time by taking advantage of the matching polarity of all Arc-Segments constituting the drive-rotor(s) to attract together when assembled through the use of jigs and hold themselves in place while the Cyanoacrylate bonding agent cures and facilitates machining to the finish dimensions incorporating the 0.015″±0.002″ clearance between the stator and drive-rotor by wet grinding to the tolerance of ±0.001″ then applying a 0.0005″ (5 ten-thousandth) Ni (nickel) protective coating by electroless plating.

The drive-rotor(s) casting is a cylinder 0.125″±0.031″ oversize on the OD and undersize on the ID plus 0.250″±0.031″ over in length then machined to finish dimensions that correlate to their opening size between the stators being 0.375″±0.005″ narrower than the opening width which equates to 0.1875″±0.002″ clearance between the stator and drive-rotor body whose final overall height/length is determined by the distance from the face of the drive-plate's drive-rotor mounting rings to their respective uppermost point of the rare earth magnets alignment to the stator for operation then the drive-rotor body in recessed-in inside and out to accommodate the Neodymium magnet Arc-Segments grade “N48H” 0.002″±0.001″ less than the Arc-Segments inside radius on the OD and greater than the outside radius on the ID the length of the recess corresponds to the length of the Arc-Segments, the mounting base is drilled and tapped evenly spaced on center to accommodate ½″-20 unf×1¾″ socket head cap screws to a depth of 1.100″±0.025″ on its median diameter plus drilled and reamed to accept 15 Tungsten Carbide dowel/location pins 0.500″±0.000″ to a depth of 0.750″±0.025″ and spaced 22.5° apart on center on that same median diameter where the remaining unoccupied position represents the timing line to reference for stator construction, the largest drive-rotor has positioned on its top median diameter 55 Neodymium magnet Discs 1.000″OD evenly spaced 6.5454°(6°32′43″) on center so when rotating at 357.4 RPM equating to 3250 SFM on this median diameter it is generating an equal duration and evenly timed episode of contact frequency/signal 17,747 Hz when working together with a Hall-Effects sensor for monitoring its rotational speed.

All drive-rotor body's (magnets not included) unless otherwise stated maintain tolerances of ±0.005″ and dimensions stated for Neodymium Magnet Arc-Segments are standards set by the industry for ordering with all segments polarity on the outside radius North; drive-rotors No 1 through No 3 have the following specifications: No 1 the body/wall thickness is 1.312″ positioned at 10.6875″ID×13.3125″OD×10.2188″H with 16 mounting screws spaced 22.5° apart on a 12.000″BC there are 24 magnet Arc-Segments per side 8.203″L×12°W×3° spacing, the inside segments have a 5.0025″IR×5.2525″OR and finish ground to 10.515″ID±0.002″ the outside segments have a 6.4975″IR×6.7475″OR and finish ground to 13.485″OD±0.002″, No 2 the body/wall thickness is 1.4375″ positioned at 21.6875″ID×24.5625″OD×9.7188″H with 32 mounting screws spaced 11.25° apart on a 23.125″BC there are 48 magnet Arc-Segments per side 7.203″L×6°W×1.5° spacing, the inside segments have a 10.7525″IR×11.0025″OR and finish ground to 21.515″ID±0.002″ the outside segments have a 12.1225″IR×12.3725″OR and finish ground to 24.735″OD±0.002″, No 3 the body/wall thickness is 1.5625″ positioned at 33.1875″ID×36.3125″OD×9.328″H with 48 mounting screws spaced 7.5° apart on a 34.750″BC there are 72 magnet Arc-Segments per side 6.406″H×4°W×1° spacing, the inside segments have a 16.5025″IR×16.7525″OR and finish ground to 33.015″ID±0.002″ the outside segments have a 17.9975″IR×18.2475″OR and finish ground to 36.485″OD±0.002″.

An accelerated heat dissipating mounting back Reference Claim No 3 of “MAW-DirectDrives” Non-provisional Utility Patent No US 2009-0255742 A1 is used to hold the innermost stator and has the following dimensions: the wall thickness is 0.625°W±0.005″ positioned at 6.250″ID±0.005″×7.500″OD±0.005″×12.000″H±0.005″ with 8 threaded holes 0.750″±0.010″D for ⅜″-24 unf×1¼″L socket head cap screws (typical screw for all mounting backs) spaced 45° apart on a 6.875″BC.

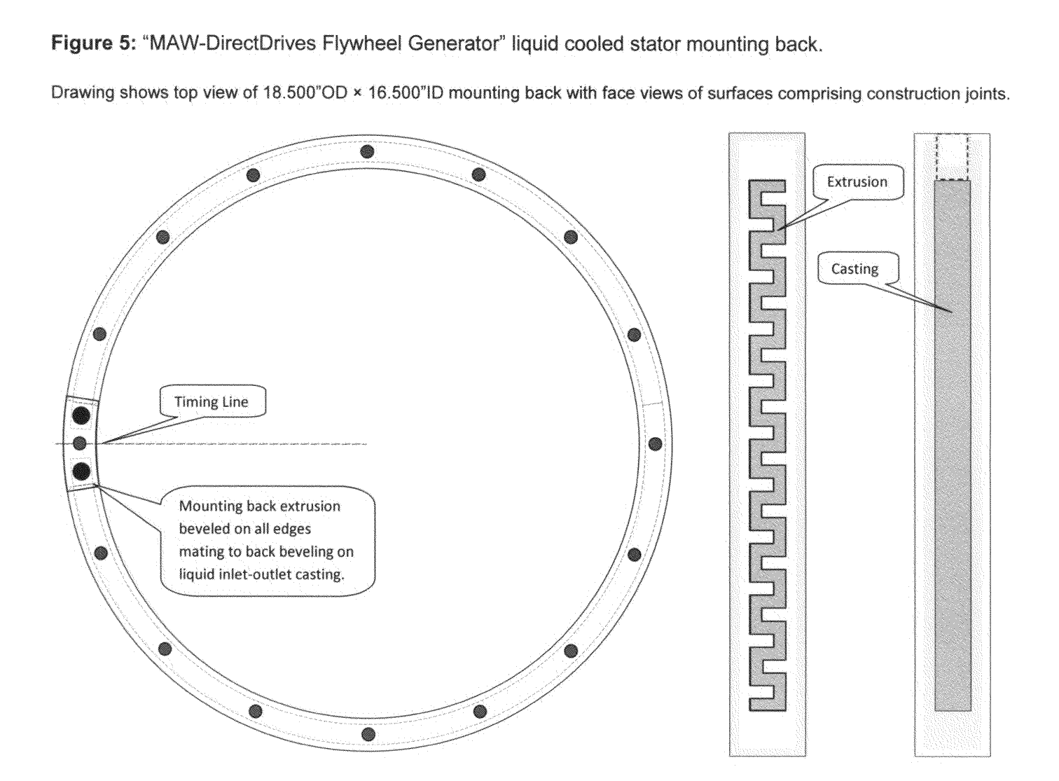

Water cooled stator mounting backs are formed by welding two components together as shown in “FIG. 5”, the major portion or body which incorporates a custom water passageway is an extrusion made of Wrought Aluminum Silicon Bronze Standard composition CuAl6Si2Fe conforming to ASTM B249 standards whereas the connecting point/part being the “Fluid inlet-outlet casting” is die casted and made of Cast Aluminum Silicon Bronze Standard composition CuAl5Si2Fe conforming to ASTM 6283 REV A standards, these parts are welded together by “Gas Shielded Arc Welding” using a filler alloy of the same composition then a post weld heat treatment is preformed, the weld joints are prepared by incorporating the corresponding angle to the extrusion ends and edges of the casting relating to the casting's width and its degree of involvement within the diameter of the part then the end's of the extrusion are beveled on all four edges and the casting incorporates a corresponding reverse beveling, the extrusion's water passageway is uniform in size and composition irrespective of diameter and the wall thickness between the passageway and exterior grow corresponding to the growth in diameter, the standard configuration for the water passageway is centered within a 12.000″H±0.005″×1.000″W±0.005″ minimum width extrusion with the following specifications: 10.250″H±0.005″×0.600″W±0.005″ with 20 projections 0.250″H±0.005″×0.400°W±0.005″ positioned 10 at right and 10 at left maintaining a 0.200″ clearance between projection ends and the opposite side and a 0.250″ clearance from the top and bottom to the 1^{st} projection plus between overlapping projection ends with all corners and projection ends R 1/32″, the casting's water chamber openings on both sides mirror the dimensions of the extrusion to a depth facilitating 0.875″±0.005″stock between chambers for one mounting screw located on the timing line and each chamber has machined in a 6/8″-20 unf threaded hole to accept plumbing fixtures, so the three water cooled mounting backs associated with the patent application's reference version will be identified from smallest to largest as No 1 through No 3 and have the following specifications: No 1 the inlet-outlet casting body occupies 16° on a 17.500″BC with corresponding angles on extrusion ends plus 1° per side added for back beveling and will be 1.000°W±0.005″ with a wall thickness 0.200″W±0.005″ finished dimensions are 16.500ID±0.005″×18.500″OD±0.005″ with 16 threaded mounted holes spaced 22.5° apart on a 17.500″BC; No 2 the casting occupies 10° on a 28.875″BC with 0.5°(30′) for back beveling and will be 1.125″W±0.005″ with a wall thickness 0.2625″W±0.005″ finished dimensions are 27.750″ID±0.005″×30.00″OD±0.005″ with 32 threaded mounting holes spaced 11.25°(11°15′) apart on a 28.875″BC; No 3 the casting occupies 7° on a 40.750″BC with 0.36°(21′36″) for back beveling and will be 1.250″W±0.005″ with a wall thickness 0.325″W±0.005″ finished dimensions are 39.500ID±0.005″×42.000″OD±0.005″ with 44 threaded mounting holes spaced 8.18°(8°10′54″) apart on a 40.750″BC.

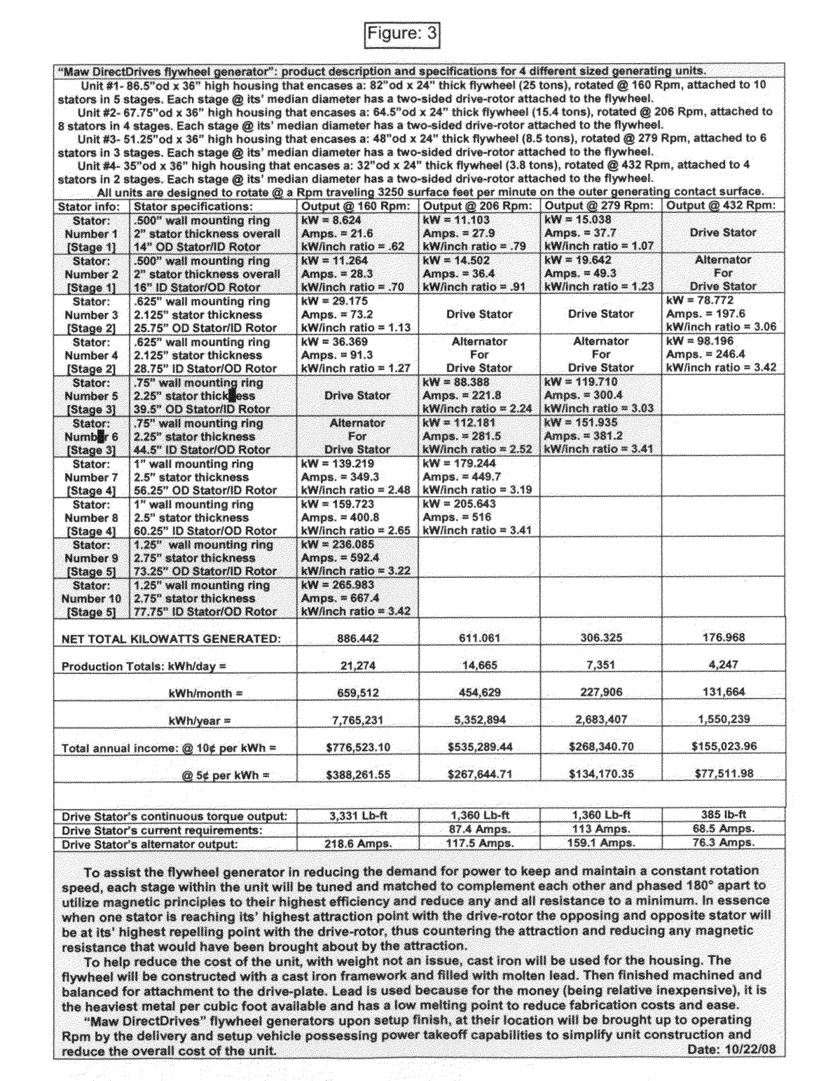

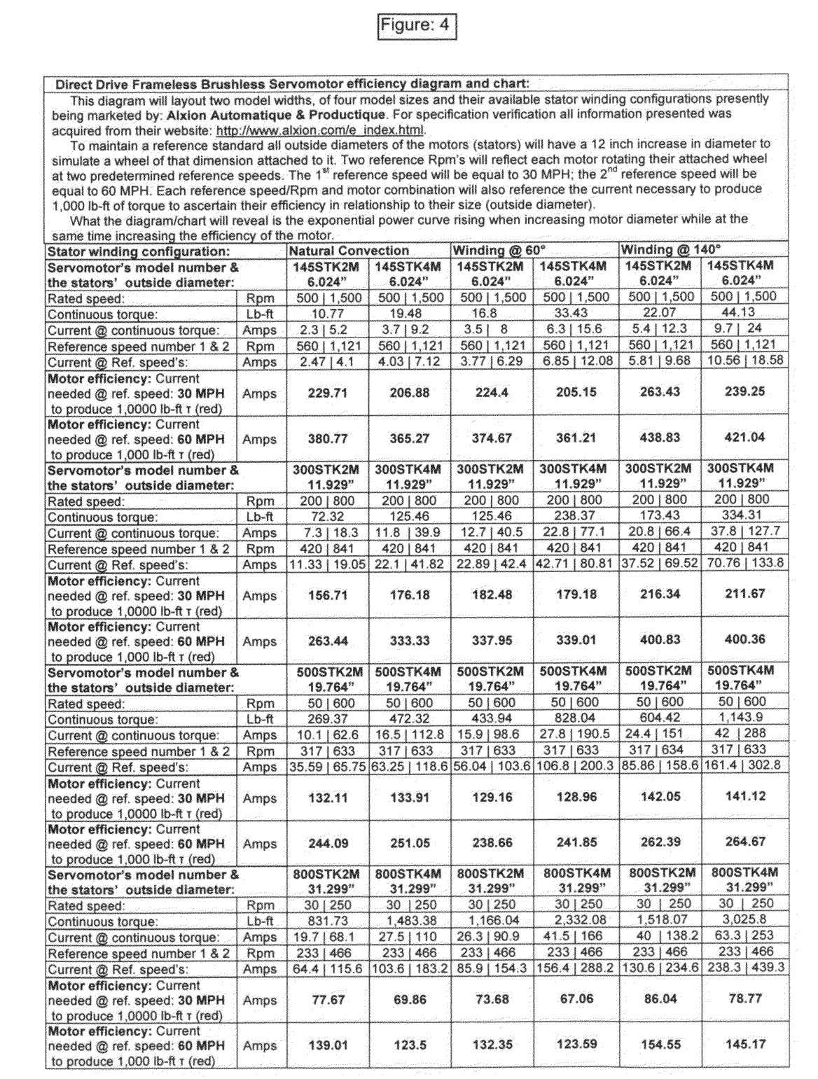

A variety of companies today construct and/or market stators for frameless direct drive applications such as Polar Power Inc., Northern Power Systems, Kollmorgen, Applimotion Inc. and Alxion Automatique&Productique and all can produce products to fit within the confines presented within the specifications; Alxion's product line served as the basis for calculating output production capabilities shown in FIG. 3 and FIG. 4 and are represented in the relationship of the size of magnets on drive-rotors to the stator height and diameter depicted in the six stator version used in this application as an example to enable setting standards and specifications capable of cross-referencing.

The twelve inch height specification for the liquid cooled stator mounting backs provides an ample platform for mounting the highest stators on the market today producing the greatest output but if a shorter stator is desired centering it on the mounting back affords even greater cooling.

The stator(s) are encapsulated in resin and machined on the face only to the finished dimensions which starting from the smallest are for stator No 1 is 10.500″OD±0.002″, No 2 is 13.500ID±0.002″, No 3 is 21.500″OD±0.002″, No 4 is 24.750ID±0.002″, No 5 is 33.000″OD±0.002″ and No 6 is 36.500ID±0.002″.

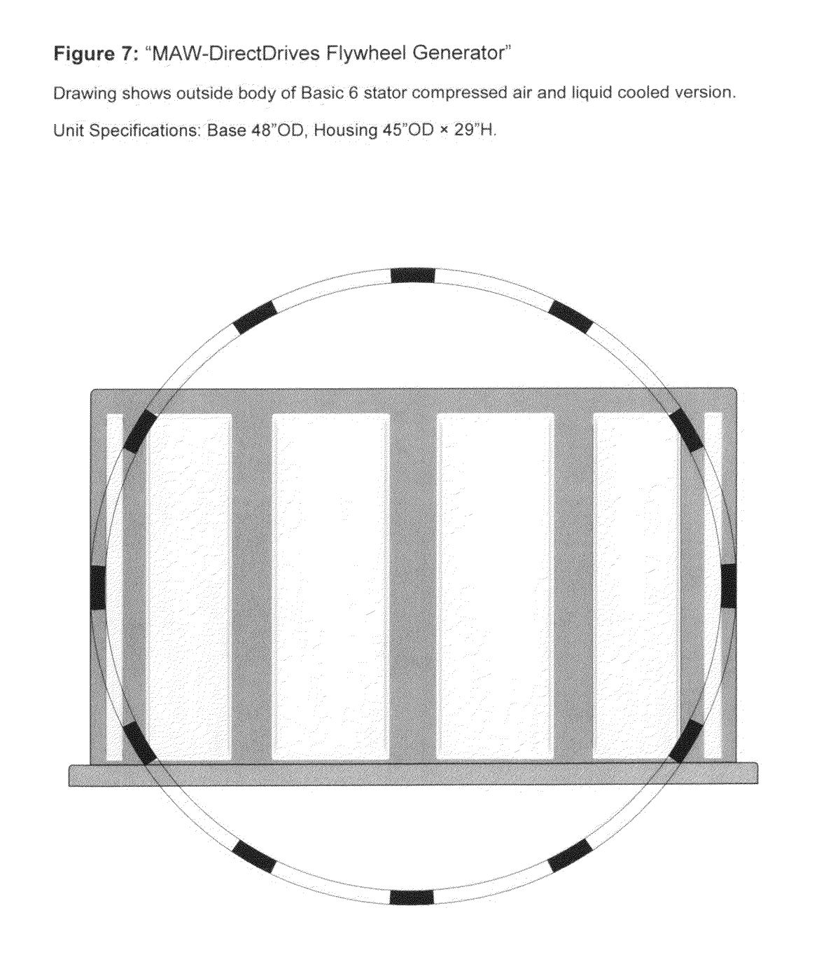

The stationary housing is a sand casting made utilizing air-set molds made of synthetic (lake) sand for the proper grade finish and is made using 771.0 casting grade aluminum alloy with a T6 temper conforming to ASTM B26/B26M standards and needs finish dimensioning only to the wheel hub ID, the following specifications comprise the stationary housing's casting: the mounting base is 48.000″OD±0.030″×1.500″H±0.030″ stepping inward to the main body 45.000″OD±0.030″×28.000″H±0.030″ overall with an interior 43.000ID±0.030″×27.000″H±0.030″ facilitating a 1.000″±0.030″ wall thickness throughout with a central wheel hub projecting down from the top 13.000″H±0.030″×6.000″OD±0.030″×4.000″ID±0.030″ counterbored to 4.250″ID±0.000″ for inner and outer sealed taper roller bearings up from lower inside to 11.750″±0.010″ from inside top surface and down from top terminating 2.750″±0.010″ from inside top surface (ref. FIG. 1) circumnavigating the base OD are 12 air filter openings (ref. FIG. 7) positioned 30° apart on center occupying 22° in width and the height is 24.000″±0.015″ set down from the top 2.000″±0.015″ the vertical supports occupy the remaining 8° of space to account for the 30° increments, the top edges of the mounting base and housing receive a 0.125″R and all air filter openings inside and out receive a 0.031″R on all edges, the casting requires approximately 3 cubic ft. of material and weighs approximately 500 lbs.

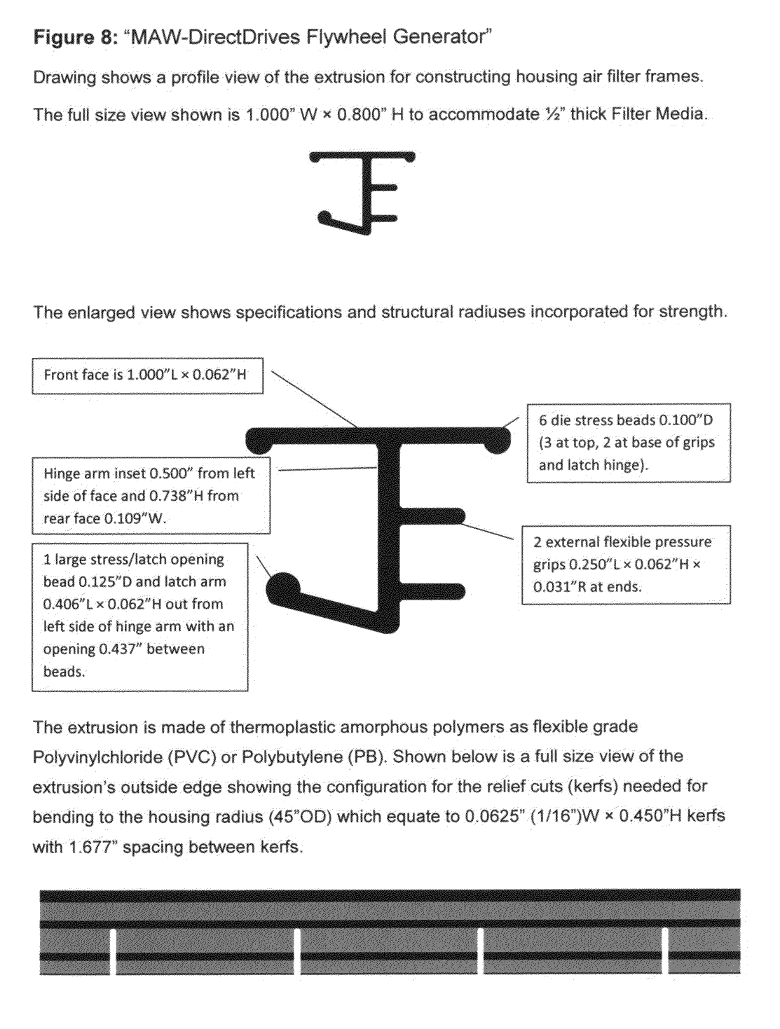

The air filters are designed to be both rigid and flexible and held in place by a custom extrusion capable of gripping into the contoured opening relative to the radius and actuate sealing properties at the same time, plus be reusable with easy disassembly and assembly (ref. FIG. 8), the extrusion is designed to slip over the edges and grasp ½″ thick air filter media like Permalast® and ATI® foam filter media, both reusable and washable that is cut 0.563″( 9/16″)±0.031″( 1/32″) undersize from the opening size and then just pushed in to hold the filter in place.

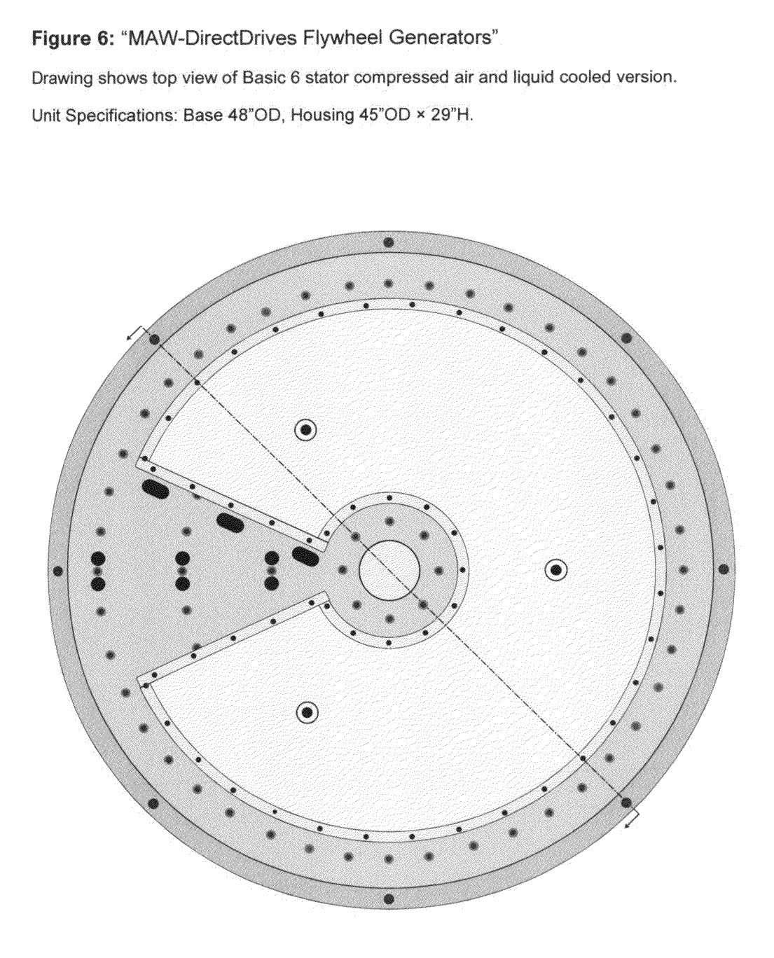

The stationary housing requires one type of milling operation performed on top to facilitate wiring harnesses associated with the operation which are three 1.000″ OD holes elongated 1.000″ positioned centered directly above the centerlines of the drive-rotors, equating to their respective bolt circle (BC) milled in a straight line on a 25° angle off the timing line at the point 3.250″ left of center (ref. FIG. 6), all the remaining work preformed to the housing are drilling, counterboring and threading operations, beginning with the mounting base and working inward are as follows: the mounting base has 8 holes 0.750″OD evenly spaced 45° apart on a 47.500″BC. all stator mounting backs utilize ⅜″-24 unf×1¼″ socket head cap screws requiring 0.375″OD±0.002″ through holes in the housing top counterbored to 0.562″OD±0.002″×0.390″D±0.010″ and liquid cooled mounting backs require 0.9375″OD through holes for plumbing in the housing top positioned on center a specific degree±off the timing line in both directions on their respective BC, liquid cooled back No 3 has 44 mounting holes evenly spaced 8.18°(8°10′54″) apart on a 40.750″BC with the plumbing holes 2.169°(2°10′9″) off the timing line, liquid cooled back Ng 2 has 32 mounting holes evenly spaced 11.25°(11°15′) apart on a 28.875″BC with the plumbing holes 3.061°(3°3′39″) off the timing line, liquid cooled back No 1 has 16 mounting holes evenly spaced 22.5° apart on a 17.500″BC with the plumbing holes 5.051°(5°3′4″) off the timing line, the inner air cooled back has 8 mounting holes evenly spaced 45° apart on a 6.875″BC, the remaining procedures are for the compressed air chamber/encasement requiring drilling through holes with a size “Q” drill and threading with a ⅜″-24 unf tap to facilitate the mounting of the compressed air chamber casting using ⅜″-24 unf×1¼″ button head socket cap screws, the location points for these procedures are as follows: 32 screws evenly spaced 10° apart on center located on a 37.750″BC with the first point 25° off the timing line and 9 screws evenly spaced 30° apart on center located on a 10.250″BC with the first point 30° off the timing line then 10 screws 5 above and 5 below the timing line projecting out at a 25° angle off the timing line at the point 0.375″ left of center evenly spaced 3.000″ apart on center with the first point intersecting a 12.000″OD position.

The compressed air chamber/encasement (ref. FIG. 1 and FIG. 6) is also a sand casting utilizing air-set molds made of synthetic sand and casted with 771.0 casting grade aluminum alloy with a T6 temper conforming to ASTM B26/B26M standards as the stationary housing but is a finished product upon casting except for the 3 threaded holes needed for air input lines being 49/64″OD through holes threaded with a ⅞″-9 unc tap that are evenly spaced 120° apart on a 23.156″BC with the first hole centered 60° off the timing line and all into their corresponding 1.500″OD±0.030″×0.500″H±0.030″ protuberance on the casting's top, all the mounting holes are 0.404°OD(“Y” gauge drill)±0.030″ and casted into the 0.750″W±0.030″×0.500″H±0.030″ bosses surrounding the 37.000″OD±0.030″×11.000ID±0.030″×1.000″H±0.030″ annular shaped housing which encompasses 310° of that area positioned 25° off the timing line set on 25° angle projection lines originating 0.375″ left of center on the timing line shooting out above and below having a wall thickness of 0.250″W±0.010″, the mounting hole locations points on those bosses will match threaded hole location points on the housing top which are 32 holes evenly spaced 10° apart on center on a 37.750″BC with the first point 25° off the timing line plus 9 holes evenly spaced 30° apart on center on a 10.250″BC with the first point 30° off the timing line and 5 holes per end evenly spaced 3.000″ apart on center and centered on the boss set-in 1.250″ from the smallest diameter equating to 12.000″OD.

Securing the compressed air chamber/encasement to the housing top requires a gasket having the same footprint as the compressed air chamber's and will be die cut out of 1/16″ thick Silicone/PTFE/EPTFE gasket material.

What is claimed is:

1. A self-contained directly driven flywheel actuated current density augmenter and electrical recharge mechanism, said current density augmenter and electrical recharge mechanism comprising: one balanced rotating large-scale solid cylindrical shaped energy storage mass suspended within a structurally sound stationary housing affixed to a strong sturdy casted metal drive-plate configured to expand the working surface area in the form of a wagon wheel possessing at center a stiff well-built solid shaft projecting upward machined true to facilitate sealed inner and outer taper roller bearings and threaded upward from the point preceding the top edge of the outer taper roller bearing an equidistance to the thickness of the locknut stepping down to the final ending dimension possessing a groove to accept an external retaining ring set above the end of the lock nut an equidistance to the thickness of a heavy spacing washer incorporating the use of shim washers completely filling any void to lock and secure the drive-plate and spindle sub-assembly to the stationary housing via a cylindrical shaped central wheel hub projection coming down from the stationary housing top also securing inside via counterbored through holes in the top from two to five tuned and matched pairs of frameless direct drive permanent magnets brushless and synchronous alternator/motor stators that radiate out from the central wheel hub assembly mounted on dual side mount custom liquid cooled stator mounting backs in the form of rectangular metal tubing internally reinforced on each side with interlaced horizontal ribbing with mounted stators encapsulated in resin and machine wet ground to finish specification and positioned by diameter of said tuned and matched pairs facing one another and separated between to facilitate the insertion and interaction of their respective rigid thickset cylindrical shaped two-sided permanent magnets drive-rotor secured to the top side of the drive-plate and spindle sub-assembly possessing on both sides equal numbers of the strongest Neodymium magnet Arc-Segments located exactly on the same projection lines off center being equal in length and strength with matching polarity on the larger radiuses creating a tuned and complementary relationship to work in union and in unison with their respective tuned and matched pair of stators within a clean and thermally controlled environment having cold compressed air entering the housing via numerous inlet holes in the housing top kept maintained with pressure by a compressed air chamber housing secured to the housing top fed by multiple input lines and exiting the housing with the warmed air via exhaust holes in the drive-plate and incorporated clearances built into the specifications out through custom air filters fabricated into the stationary housing circumference to enable the ability of electrical input needed for its operation to actuate angular momentum to a work surface area capable to encompass the needs to operate the specified number of stages to produce the desired current density boost and/or recharge capacity.
